(19) United States
(12) Patent Application Publication
(10) Pub. No.: US 2021/0192536 A1
(43) Pub. Date: Jun. 24, 2021

(54) SYSTEM AND METHOD FOR ADAPTIVE AGENT SCRIPTING

(71) Applicant: Avaya Inc., Santa Clara, CA (US)

(72) Inventors: Asmita Gokhale, Pune (IN); Shamik Shah, Pune (IN); Valentine C. Matula, Granville, OH (US)

(21) Appl. No.: 16/726,677

(22) Filed: Dec. 24, 2019

(51) Int. Cl. G06Q 30/00; H04L 12/58; G10L 15/22; G10L 19/00; G10L 25/63

(52) U.S. Cl. CPC G06Q 30/016; H04L 51/046; H04L 51/22; H04L 67/10; G10L 19/00; G10L 25/63; G10L 15/22

(57) ABSTRACT

Contact centers strive to successfully resolve communications with customers as efficiently and effectively as possible. While providing prompts or scripts to agents may assist in the content delivered to the customer by the agent, such prompts or scripts lack emotion and cause the agent to rely on their own determination of what is appropriate, which may not be appropriate for a particular communication with a customer. By determining and prompting an agent to utilize a particular emotion, agents may better relate to the customer and improve the opportunity to successfully conclude the communication sooner than normal and allow resource to be utilized for other purposes.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for message insertion and directing and particularly to presenting single node signals to direct a dual-node communication.

### BACKGROUND

In a contact center, serving outbound, inbound and chat and email operations, handling customers efficiently is of prime importance. Agents are trained in real time to answer the customers in best possible manner. This real time training to the agents include agent scripting and prompting to ask better questions, seek information from the customer based on their conversation, provide better options, suggestions, and/or solutions so to the customer for their described problem.

### SUMMARY

Agents may be provided with real-time cues, such as scripts or prompts. However, the prior art failed to consider the human touch, e.g., emotions, with which an agent should handle a particular customer. Due to the lack of emotions, agents tend to treat different types of customers based on the agent's own personality and their own unique way of handling the customers. Therefore, despite having relevant real-time prompts to the agents, the entire conversation may not turn out to be very effective, which may cause customer dissatisfaction or resentment. On the other hand, a highly skilled and experienced agent would handle the same customer with reflective emotions leading to higher levels of customer satisfaction and positive takeaways.

As an example, a frustrated customer is complaining about a service disruptions or poor product quality. The usual real-time scripting and prompts to the agents would never be sufficient to handle such a customer. An inexperienced agent or an agent with contradicting personality, would likely make the situation worse as the customer is only left to the mercy of emotionless agent scripts and real time conversation based prompts.

In another example, such as during a marketing or sales campaign, an agent encounters a tough customer. The agent would offer the best deals to the customer, but in what manner? The “manner” here would correspond to the agent's own personality and the agent's own unique way of handling the customer. The real-time agent scripts would only enable agents to know “what” to speak but not “how” to say.

In addition to the above, the agents tend to spend more time on such calls trying to explain and/or convince the customers, leading to decrease in agent utilization, efficacy and efficiency.

These and other needs are addressed by the various embodiments and configurations of the present invention. The present invention can provide a number of advantages depending on the particular configuration. These and other advantages will be apparent from the disclosure of the invention(s) contained herein.

As described with respect to the embodiments herein, system and method are provided for advanced emotion-based agent scripting and prompting for real-time agent training, effective handling of the customers uniformly within the contact center thereby reducing the need for specialized agents.

The real-time speech analysis may be utilized to understand the context of the conversation and provide real-time agent prompts to the agent to either seek more information or provide particular content. However, these methods are often insufficient to handle customers in the most effective manner as the customer is only left to the mercy of the agent's own understanding of the problem, system prompts arising out of contextual extraction of the conversation, and agent's own way of handling the customer, which may not be effective or according to company standard.

The prior art may provide agents scripts and prompts based on real-time speech analysis do not describe how a particular customer should be approached given the context at hand. However, systems and methods disclosed herein are directed towards the selection of the right type of emotion required to handle a particular type of customer based on several different factors, including but not limited to:

1. Customer information, personality type of the customer;

2. Real-time analysis of the context of the conversation;

3. Speech and tone analysis of the customer describing the emotion of the customer (e.g., angry, happy, dissatisfied, frustrated, depressed, etc.);

4. Past history of type of interaction with the customer (e.g., successful, unsuccessful, satisfied, dissatisfied, etc.);

5. Past history of problems/issues/requirements of the customer;

6. Current ongoing latest, highest and average issues/requirements in the contact center overall and their resolutions; and

7. Dictionary of words.

When one or more of the above set of data is mined and fed into a machine learning algorithm, an accurate outcome can be obtained describing “how” a particular type of sentence should be delivered to a particular type of customer given the context at hand.

In one embodiment, a configurable color-coding scheme can be used to highlight the sentences wherein a particular color indicates a specific emotion to be used while delivering that word, phrase, sentence, etc. Individual words can also be highlighted or color-coded differently describing the amount of emphasis required on that word or collection of words.

In another embodiment, the prompting may comprise a specific word-choice from a dictionary. The selection of the word may be based on the current context, as well as the customer's personality and emotion. For example, when the customer's sentiments are negative the selection of words to be should be more submissive and affirmative and the corresponding emotions should be empathetic and not dominant or confident.

This will increase the acceptability rate of the answers delivered to the customer. The right choice of sentences, with emphasis on the impactful words with proper reflective emotions would make the conversation more satisfactory and efficient. As the acceptability rate increases, time required to conclude a conversation is reduced, leading to higher agent utilization and high customer satisfaction.

As a result of certain embodiments disclosed herein, agents are provided with emotion-based prompts to disengage their own personality and “wear” a pseudo-personality that is reflective and adaptive to the customer and the conversation. As a result, the need to have agents skilled in applying such emotions is drastically reduces. Essentially, different personality type of customers, with same or different emotions with regard to a particular issue, will be handled by different type of agents uniformly in the entire contact center.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall rover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 1 depicts a second system in accordance with embodiments of the present disclosure;

FIG. 3 depicts a first data structure in accordance with embodiments of the present disclosure;

FIG. 4 depicts a second data structure in accordance with embodiments of the present disclosure;

FIG. 5 depicts a first process in accordance with embodiments of the present disclosure;

FIG. 6 depicts a second process in accordance with embodiments of the present disclosure; and

FIG. 7 depicts a third system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

In one embodiment, a system is disclosed, comprising: a network interface to a network; a microprocessor; and wherein the microprocessor performs: accessing a communication between a customer communication device, associated with a customer, and an agent communication device, associated with an agent, and wherein the communication comprises audio encoded from speech provided by at least one of the agent and the customer; determining a target emotion for the communication; selecting a first emotion prompt associated with the target emotion; and causing the agent communication device to present the first emotion prompt to the agent.

In another embodiment, a method is disclosed, comprising, accessing a communication between a customer communication device, associated with a customer, and an agent communication device, associated with an agent, and wherein the communication comprises audio encoded from speech provided by at least one of the agent and the customer; determining a target emotion for the communication; selecting a first emotion prompt associated with the target emotion; and causing the agent communication device to present the first emotion prompt to the agent.

In another embodiment, a method is disclosed, comprising: means to access a communication between a customer communication device, associated with a customer, and an agent communication device, associated with an agent, and wherein the communication comprises audio encoded from speech provided by at least one of the agent and the customer; means to determine a target emotion for the communication; means to select a first emotion prompt associated with the target emotion; and means to cause the agent communication device to present the first emotion prompt to the agent.

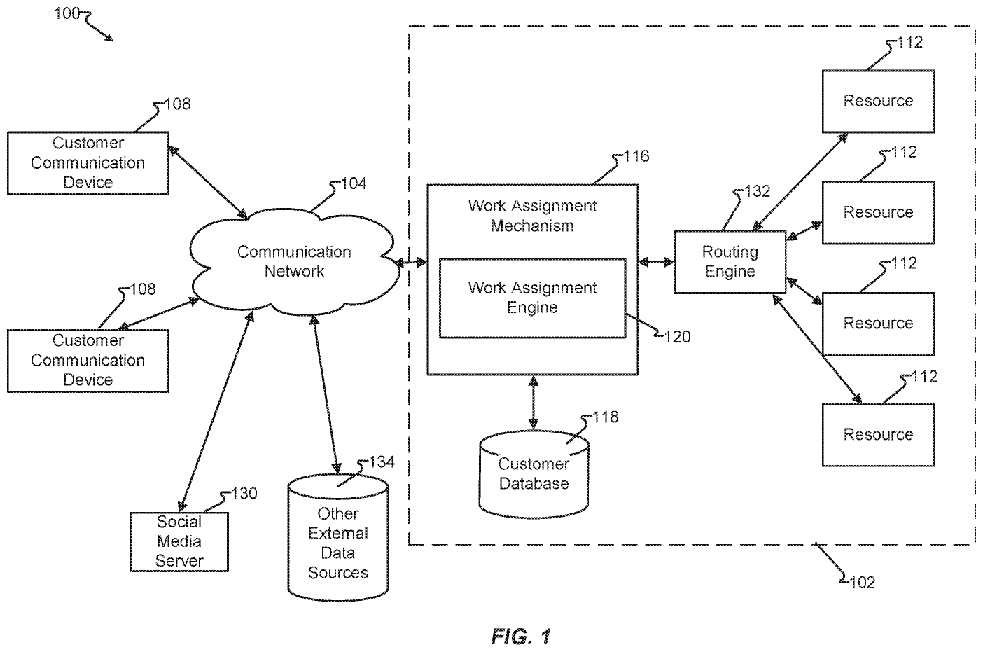

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server 130. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102. Herein, the embodiments are entirely directed towards human agents utilizing an agent communication device as a node on communication network 104 and in commutation with at least one other node on communication network 104, namely, a particular customer communication device 108. The agent communication device comprising at least a microphone to capture speech from the agent and encode the speech for transmission via communication network 104 to customer communication device 108 for presentation by a speaker to the customer. Similarly, customer communication device 108 comprises a microphone (not shown) to encode speech from the customer for transmission via communication network 104 for presentation to the agent via a speaker associated with the agent communication device. Customer communication device 108 and/or the agent communication device may comprise other input-output devices, such as a video display and camera for the capturing, encoding, transmission via communication network 104, receiving, decoding, and presentation of video images.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage elements may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

FIG. 2 depicts system 200 in accordance with embodiments of the present disclosure. As illustrated and described with respect to FIG. 1, contact center 102 may utilize various embodiments for resources 112 and may include human (or “live”) agents utilizing an agent communication device for conversion to encoded signals to be conveyed to the customer via communication network 104, as well as, automated agents (e.g., expert systems, interactive voice response, etc.). In the embodiments that follow, resources 112 are embodied solely as live agents 210 utilizing their respective agent communication device 220 and excludes automated or other machine-based agents.

Agent 222 is each associated with a respective agent communication device 220. Agent communication device 220 comprises a speaker/microphone, such as in the form of a headset, to convert sound energy into and from encoded communication signals for transport via communication network 104. In other embodiments agent communication device 220 may support additional forms of communication, such as video, co-browsing, etc. in addition to audio in the form of speech.

Customer 202 may utilize customer communication device 108 that is variously embodied but, herein, is embodied to comprise at least speaker 212 to present encoded audio data, such as speech originating from agent 222, into sound energy. Microphone 206 may be utilized to capture speech from customer 202 for encoding for transport via communication network 104, which may then be presented as sound energy to agent 222 engaged in the communication with customer 202. Camera 208 may capture images, such as for a video conference.

In another embodiment, server 216 may be embodied as, co-embodied with, or embodied by one or more of work assignment mechanism 116 and/or work assignment engine 120. Server 216 may monitor, at least an audio portion, of the communication between customer 202 and agent 222, such as to determine what words, phrases, and/or emotional content is present in the communication. Server 216 may access data structures in database 218 to match particular content to a particular target response for agent 222. Database 218 may comprise data, such as in the form of data structures illustrated with respect to certain embodiments that follow, rules, algorithms, machine-readable and executable instructions, etc. Database 218 may be embodied as a storage for data in the form of a storage device or component or other non-transitory storage and be accessible to a microprocessor (not shown), such as of server 216 and/or agent communication device 220 to determine and execute a particular emotional prompting to agent 222.

In another embodiment, data for a particular emotion and/or target emotional response to be applied by agent 222 may be maintained in database 218 and/or customer database 118, such as when a customer has a known past emotional response and/or reaction to an emotion provided by an agent in a past interaction. For example, customer 202 may be known to respond well to an authoritative agent, even when expressing a negative emotion (e.g., angry, frustrated, etc.). In contrast, customer 202 may have responded better in the past to agents who were happy or otherwise expressed a positive emotion that customer 202 may have found to be disarming. When customer 202 is not known, rules may be maintained in database 218 for categories of customers when the identity of the customer is entirely unknown or only categorical information is known (e.g., member of a particular demographic group) and/or content of a particular communication. For example, a particular customer 202 may be calling about their retirement benefits and, therefore, be known to be in a group comprising retired persons. In contrast, a particular customer 202 may be calling about a tuition charge and, therefore, be known to be in a group comprising students. Accordingly, a particular target emotion may be determined for a generic person, with no known identifying characteristics, a particular group of persons, or a specific user. Additionally, the content of the communication may comprise particular subject matter, words or phrases, or customer-provided emotional content which may further determine a particular emotional response to be applied by agent 222.

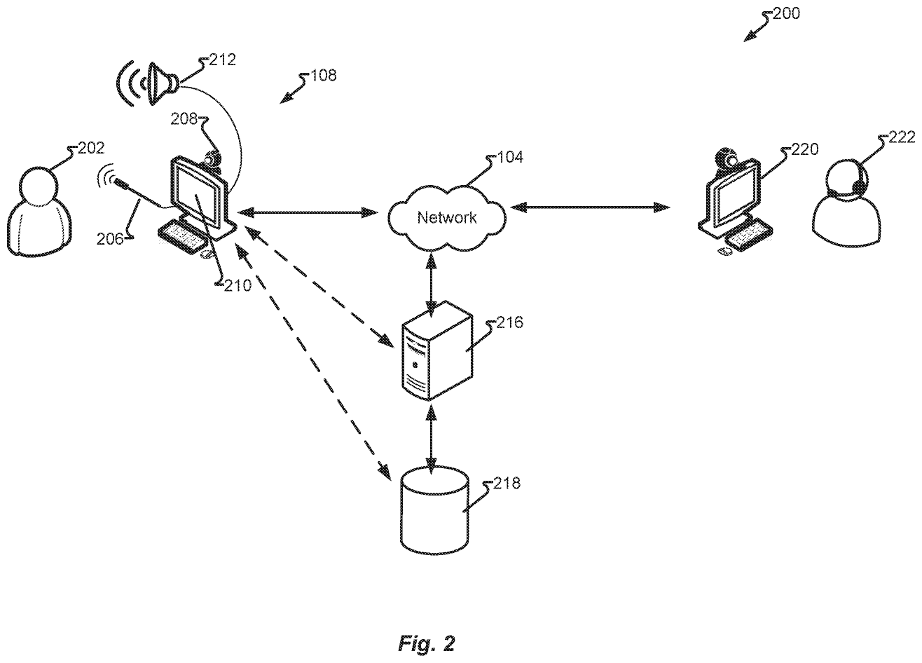

FIG. 3 depicts data structure 300 in accordance with embodiments of the present disclosure. In one embodiment, data structure 300 is maintained in a dedicated or shared storage device, such as database 218 and accessible to a microprocessor, such as a microprocessor of server 216 and/or agent communication device 220. Data structure 300 comprises a number of records 306 whereby content 302 of a communication is associated with a target agent emotion 304. For example, if customer 202 is currently engaged with agent 222 and, as detected by server 216 monitoring the communication, the communication comprises a discussion of lost luggage, server 216 may determine a match with content 302 in record 306B and, accordingly, determine the appropriate target emotion for agent 222 is authoritative. Additionally or alternatively, the target emotion may be determined by prior history of the client (e.g., whether past instructions have been successful/unsuccessful, satisfied/unsatisfied, etc.), the particular problem, issue, or requirement of the customer and/or current ongoing latest, highest and average issues/requirements in the contact center overall and their resolutions.

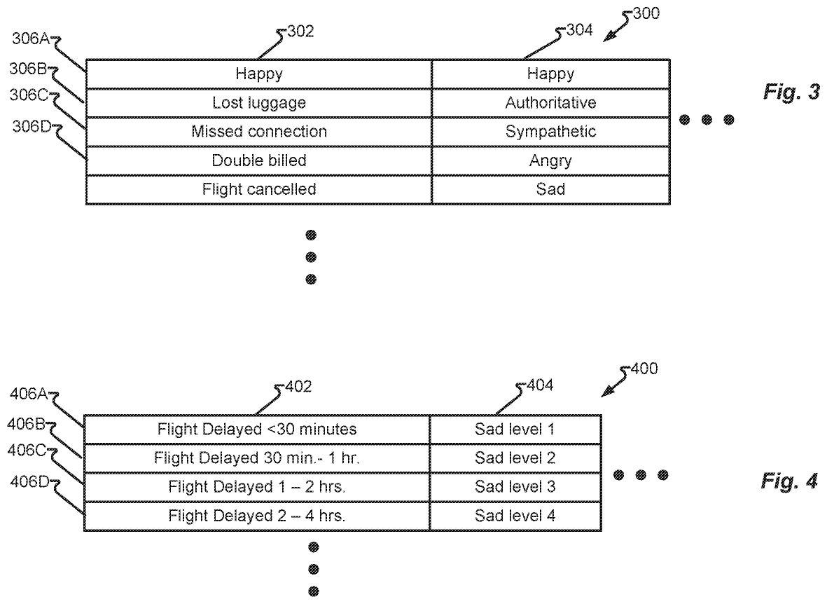

FIG. 4 depicts data structure 400 in accordance with embodiments of the present disclosure. Similar to data structure 300, and in one embodiment, data structure 300 is maintained in a dedicated or shared storage device, such as database 218 and accessible to a microprocessor, such as a microprocessor of server 216 and/or agent communication device 220. Data structure 400 comprises a number of records 406 indicating having a degree or severity of communication content field 402 and an associated degree of a particular target emotion 404. While data structure 400 illustrates degree or severity of communication content field 402, it should be appreciated, that other aspects may be utilized with respect to data structure 300 and/or data structure 400, such as past history, past interactions, current ongoing issues/requirement of the contact, center, default values, demographic values, and/or values associated with a specific customer 202, in addition or alternatively to the content of the communication.

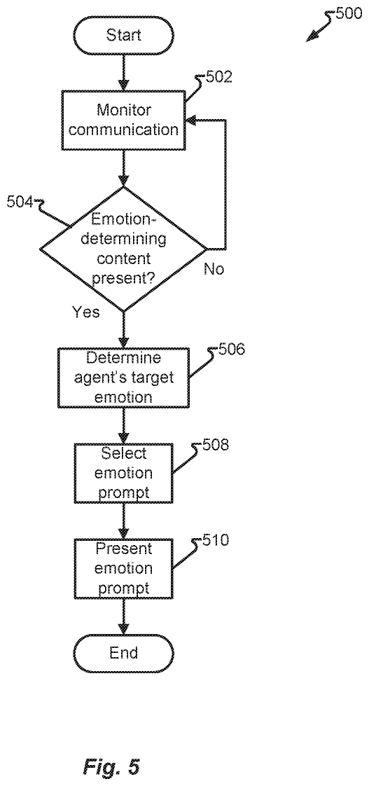

FIG. 5 depicts a process 500 in accordance with embodiments of the present disclosure. In one embodiment, process 500 is executed by a microprocessor, such as may be a component of server 216 and/or agent communication device 220. Process 500 begins and step 502 monitors a communication between customer 202, utilizing customer communication device 108 and agent 222, utilizing agent communication device 220 to communicate via communication network 104. Test 504 determines if emotion-determining content is present in the communication, in other words, if a target emotion for agent 222 may be determined from at least a portion of the communication, such as in the audio portion of the communication comprising speech from at least customer 202. In another embodiment, video content is monitored such as to determine if an image of customer 202 captured by camera 208 indicates a particular emotional response should be provided by agent 222. If test 504 is determined in the negative, process 500 may continue to loop back to step 502 until interrupted, such as by the termination of the communication or until test 504 is determined in the affirmative.

When test 504 is determined in the affirmative, step 506 determines a target emotion for agent 222, such as by accessing a rule and/or data structure, including but not limited to data structure 300 and/or data structure 400. Step 506 determines, from the emotion-determining content found present in test 504, and step 508 selects a response, associated with the target emotion, a prompt to provide to agent 222, such as audibly and/or visually by agent communication device 220. Step 510 then causes agent 222 to be presented with the prompt designed to cause agent 222 to present the target emotion determined in step 506.

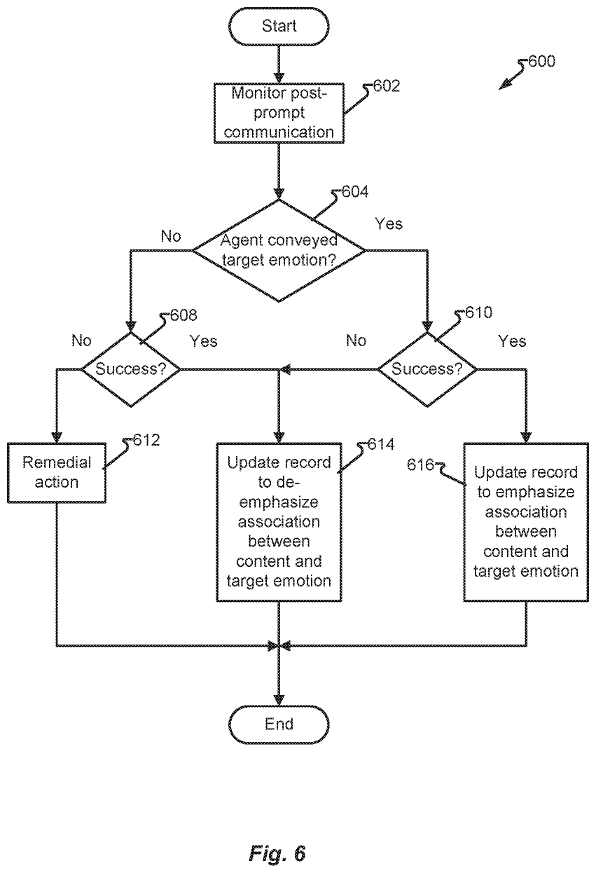

In one embodiment, process 500 is performed to promote a better relationship, goodwill, and/or effective communication between contact center 102, such as provided by agent 222, and customer 202. In order to determine if such an objective has, or has not, been reached, the position of agent 222 may be monitored and determined if such a position has been changed following agent 222 providing the target emotion, such as in response to step 510. For example, customer 202 may be angry, such as due to perceived or actual bad service, hold a negative view of the company or enterprise that motivated the communication, etc. Accordingly, it may be an objective to improve the emotional state of agent 222 and/or the view of the company held by customer 202. When customer 202 has a neutral or positive emotion or perspective, a change in position may be to further improve the emotion or perspective. Accordingly, when successful, the rule and/or data that associates the target emotion with success of the communication, such as when the communication is based on a work item (e.g., providing a service, resolving an issue, providing information, etc.) that was the reason for the communication, may be enhanced or, when unsuccessful, de-emphasized, as will be more thoroughly described with respect to FIG. 6.

FIG. 6 depicts process 600 in accordance with embodiments of the present disclosure. In one embodiment, process 600 is executed by a microprocessor, such as may be a component of server 216 and/or agent communication device 220. Process 600 may be initiated following execution of step 510 (see FIG. 5). Step 602 monitors the communication between agent 222 and customer 202 following the prompting of agent 222 to provide the target emotion, in addition to substantive content (e.g., instructions, information, etc.) of the agent's portion of the communication to resolve the work item. Step 602 may continue for the duration of the communication or end upon a determination of whether or not the agent provided the target emotion in test 604.

Test 604, if determined in the negative, may then execute test 608 to determine if the communication, comprising the work item, was successful. If test 604 is determined in the negative, step 612 may be executed such as to alert a supervisor, automatically cause another node (e.g., another agent, supervisor, etc.) to be joined to the communication, etc., as may be appropriate when agent 222 was prompted to provide a particular emotion in the communication but failed to do so. In another embodiment, step 612 may comprise a re-prompting for agent 222 to provide the target emotion. For example, a more visual prominent graphical element may be presented on a display associated with agent communication device 220, a whisper message provided to agent 222, and/or other re-prompting may be provided. Accordingly, process 600 may be re-imitated and/or a new instance of process 600 may be executed to determine the result of the re-prompting. Additionally or alternatively, the prompting (such as in step 612) may be more explicit compared to the initial prompting. For example, step 510 may present words, icon, color-coded symbol or text, etc., whereas step 612 may be more explicit, such as specific examples of how to say certain things with cues as to what words or phrases to emphasize and how. Additionally, or alternatively, a whisper message may comprise an audio example of words or phrases to mimic, including all the intonations necessary to convey the target emotion, to provide a specific example to agent 222 of what to say and how to say it.

If test 604 is determined in the affirmative, indicating that agent 222 did provide the target emotion, test 610 may then determine if the communication, comprising the work item, was successful. If test 610 is determined in the affirmative, step 616 may be executed to emphasize (or made more resistant to a future de-emphasizing) of the emotion-determining content and the target emotion and/or the target emotion and the specific prompt provided to agent 222. In contrast, if agent 222 did provide the target emotion and test 610 is determined in the negative or if test 608 is determined in the affirmative, then the emotion-determining content and the target emotion and/or the target emotion and the specific prompt provided to agent 222 should be de-emphasized (or made more resistant to a future emphasis), such as to indicate that the target emotion was provided but ineffective. If test 608 is determined in the negative, then a process may be initiated to determine why the agent did not convey the indicated emotion and the failure determined in test 608.

In another embodiment, upon test 610 being determined in the negative, the call may be identified as requiring a particular agent skill (e.g., expert in a particular subject matter, language, etc.) such that routine engine 132 routes a subsequent call with similar emotion-determining content, to an agent communication device associated with such a highly-skilled agent. In another embodiment, following test 604 being determined in the negative, positive, or without regard to the outcome, agent 222 may be scored, such as self-scored, supervisor scored, machine scored, etc. to determine how they believed they performed, such as to identify any disconnects between what the agents believe they are communicating and what they are actually communicating. As a result, training needs may be identified to attenuate such differences.

In another embodiment, self-score vs quality management (QM) score is used to determine which agents require additional training on how to present emotion; self-score vs QM score is fed back into routing systems, to help route difficult-to-voice calls to agents that can do the job; and the result is fed back into the system, e.g., one or more of data structures 300 and/or 400 is updated, to possibly suggest easier-and-a good fraction effective emotions to an agent, when an agent is not very good at certain types of emotions.

As a benefit of process 600, data structures (e.g., data structures 300, 400) and/or rules may be self-modified to indicate when an agent does not provide a target emotion (e.g., test 604 is determined in the negative) but is nevertheless successful (e.g., test 608 is determined in the affirmative) the data and/or rule that selected the emotional content may be updated to utilize the emotional content actually provided by agent 222. Similarly, if a particular target emotion was provided by the agent, and was successful, then the association between the emotion-determining content and target emotion and/or the target emotion and the prompt provided to agent 222 may be determined to be correct, or at least more correct, such that a subsequent communication with similar content provided by customer 202, even if unsuccessful, may be less likely to be altered based on the past successes.

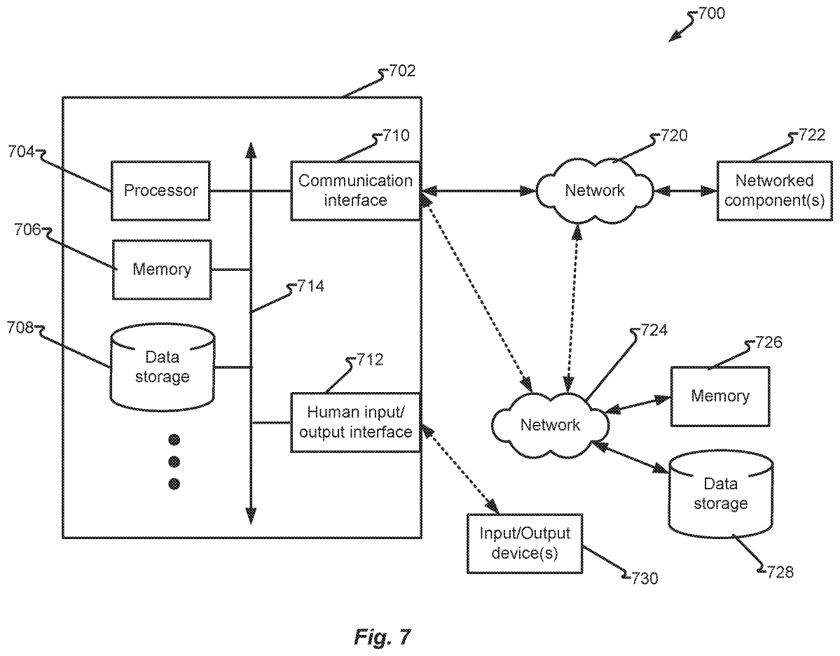

FIG. 7 depicts device 702 in system 700 in accordance with embodiments of the present disclosure. In one embodiment, agent communication device 220 and/or server 216 may be embodied, in whole or in part, as device 702 comprising various components and connections to other components and/or systems. The components are variously embodied and may comprise processor 704. Processor 704 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 714, executes instructions, and outputs data, again such as via bus 714.

In addition to the components of processor 704, device 702 may utilize memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, etc. In another embodiment, communication interface 710 may comprise, or be comprised by, human input/output interface 712. Communication interface 710 may be configured to communicate directly with a networked component or utilize one or more networks, such as network 720 and/or network 724.

Network 104 may be embodied, in whole or in part, as network 720. Network 720 may be a wired network (e.g., Ethernet), wireless (e.g., WiFi, Bluetooth, cellular, etc.) network, or combination thereof and enable device 702 to communicate with network component(s) 722.

Additionally or alternatively, one or more other networks may be utilized. For example, network 724 may represent a second network, which may facilitate communication with components utilized by device 702. For example, network 724 may be an internal network to contact center 102 whereby components are trusted (or at least more so) that networked components 722, which may be connected to network 720 comprising a public network (e.g., Internet) that may not be as trusted. Components attached to network 724 may include memory 726, data storage 728, input/output device(s) 730, and/or other components that may be accessible to processor 704. For example, memory 726 and/or data storage 728 may supplement or supplant memory 706 and/or data storage 708 entirely or for a particular task or purpose. For example, memory 726 and/or data storage 728 may be an external data repository (e.g., server farm, array, “cloud,” etc.) and allow device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720.

It should be appreciated that computer readable data may be sent, received, stored, processed, and presented by a variety of components. It should also be appreciated that components illustrated may control other components, whether illustrated herein or otherwise. For example, one input/output device 730 may be a router, switch, port, or other communication component such that a particular output of processor 704 enables (or disables) input/output device 730, which may be associated with network 720 and/or network 724, to allow (or disallow) communications between two or more nodes on network 720 and/or network 724. For example, a connection between one particular customer, using a particular customer communication device 108, may be enabled (or disabled) with a particular networked component 722 and/or particular resource 112, such as agent 222 utilizing agent communication device 220. Similarly, one particular networked component 722 and/or resource 112 may be enabled (or disabled) from communicating with a particular other networked component 722 and/or resource 112, including, in certain embodiments, device 702 or vice versa. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network;
a microprocessor; and
wherein the microprocessor performs:
accessing a communication between a customer communication device, associated with a customer, and an agent communication device, associated with an agent, and wherein the communication comprises audio encoded from speech provided by at least one of the agent and the customer;
determining a target emotion for the communication;
selecting a first emotion prompt associated with the target emotion; and
causing the agent communication device to present the first emotion prompt to the agent.

2. The system of claim 1, further comprising,
a storage device maintaining data and accessible to the microprocessor; and
wherein the microprocessor further accesses, from the storage device, a purpose for a work item associated with the communication and wherein the purpose comprises changing a perspective of the customer with regard to a subject of a work item; and
wherein the microprocessor, upon determining that the customer has changed their perspective, sets a success indicator is set to indicate success; and
wherein the microprocessor, upon determining that the customer has not changed their perspective, sets a success indicator is set to indicate failure.

3. The system of claim 2, wherein:
the data storage comprises a degree of correlation between at least one of the target emotion and the communication or the first emotion prompt and the target emotion;
the microprocessor, upon determining the subsequent portion of the communication comprises the target emotion and the success indicator indicates success, updates the degree of correlation to reinforce an association between the at least one of the target emotion and the communication or the first emotion prompt and the target emotion.

4. The system of claim 2, wherein:
the data storage comprises a degree of correlation between at least one of the target emotion and the communication or the first emotion prompt and the target emotion;
the microprocessor, upon determining the subsequent portion of the communication comprises the target emotion and the success indicator indicates failure, updates the degree of correlation to reduce an association between the at least one of the target emotion and the communication or the first emotion prompt and the target emotion.

5. The system of claim 2, wherein:
the data storage comprises a degree of correlation between at least one of the target emotion and the communication or the first emotion prompt and the target emotion;
the microprocessor, upon determining the subsequent portion of the communication does not comprise the target emotion and the success indicator indicates success, updates the degree of correlation to reduce an association between the at least one of the target emotion and the communication or the first emotion prompt and the target emotion.

6. The system of claim 1, wherein the microprocessor, upon determining the subsequent portion of the communication is absent the target emotion, initiating a corrective action comprising at least one of, signaling a supervisor communication device, providing a secondary emption prompt, or automatically joining a second agent communication device to the communication, automatically joining the supervisor communication device to the communication

7. The system of claim 6, wherein:
the microprocessor, upon further determining the success indicator indicates failure, updates the degree of correlation to reinforce an association between the at least one of the target emotion and the communication or the first emotion prompt and the target emotion.

8. The system of claim 6, wherein the microprocessor, upon determining the subsequent portion of the communication is absent the target emotion, causing the agent communication device to present a second emotion prompt to the agent.

9. The system of claim 8, wherein the second emotion prompt comprises an audio prompt presented to the agent communication device and not to the customer communication device.

10. The system of claim 8, wherein the second emotion prompt comprises an emphasized visual presentation of the first emotion prompt.

11. The system of claim 6, wherein:
the microprocessor, upon further determining the success indicator indicates success, updates the degree of correlation to reinforce an association between the at least one of the target emotion and the communication or the first emotion prompt and the target emotion.

12. A method, comprising:
accessing a communication between a customer communication device, associated with a customer, and an agent communication device, associated with an agent, and wherein the communication comprises audio encoded from speech provided by at least one of the agent and the customer;
determining a target emotion for the communication;
selecting a first emotion prompt associated with the target emotion; and
causing the agent communication device to present the first emotion prompt to the agent.

13. The method of claim 12, further comprising:
accessing, from a storage device, a purpose for a work item associated with the communication and wherein the purpose comprises changing a perspective of the customer with regard to a subject of a work item; and
upon determining the speech provided by the customer indicates the customer has changed their perspective, setting the success indicator to indicate success; and
upon determining the speech provided by the customer indicates the customer has not changed their perspective, setting the success indicator to indicate failure.

14. The method of claim 13, wherein:
the data storage comprises a degree of correlation between at least one of the target emotion and the communication or the first emotion prompt and the target emotion;
upon determining the subsequent portion of the communication comprises the target emotion and the success indicator indicates success, updating the degree of correlation to reinforce an association between the at least one of the target emotion and the communication or the first emotion prompt and the target emotion.

15. The method of claim 13, wherein:
the data storage comprises a degree of correlation between at least one of the target emotion and the communication or the first emotion prompt and the target emotion;
upon determining the subsequent portion of the communication comprises the target emotion and the success indicator indicates failure, updating the degree of correlation to reduce an association between the at least one of the target emotion and the communication or the first emotion prompt and the target emotion.

16. The method of claim 13, further comprising:
storing, in a non-transitory data storage, a degree of correlation between at least one of the target emotion and the communication or the first emotion prompt and the target emotion;
upon determining the subsequent portion of the communication does not comprise the target emotion and the success indicator indicates success, updating the degree of correlation to reduce an association between the at least one of the target emotion and the communication or the first emotion prompt and the target emotion.

17. The method of claim 12, further comprising:
upon determining the subsequent portion of the communication is absent the target emotion, initiating a corrective action comprising at least one of, signaling a supervisor communication device, providing a secondary emotion prompt, or automatically joining a second agent communication device to the communication, automatically joining the supervisor communication device to the communication

18. The method of claim 17, further comprising:
upon further determining the success indicator indicates failure, updating the degree of correlation to reinforce an association between the at least one of the target emotion and the communication or the first emotion prompt and the target emotion.

19. The method of claim 17, further comprising:
upon determining the subsequent portion of the communication is absent the target emotion, causing the agent communication device to present a second emotion prompt to the agent.

20. The method of claim 19, wherein the second emotion prompt comprises an audio prompt presented to the agent communication device and not to the customer communication device.

21. A system, comprising:
means to access a communication between a customer communication device, associated with a customer, and an agent communication device, associated with an agent, and wherein the communication comprises audio encoded from speech provided by at least one of the agent and the customer;
means to determine a target emotion for the communication;
means to select a first emotion prompt associated with the target emotion; and
means to cause the agent communication device to present the first emotion prompt to the agent.
